(19) United States
(12) Patent Application Publication
(10) Pub. No.: US 2020/0110405 A1
(43) Pub. Date: Apr. 9, 2020

(54) PARAMETER PROCESSING METHOD, DEVICE, MACHINE READABLE STORAGE MEDIUM AND SYSTEM

(71) Applicant: SZ DJI TECHNOLOGY CO., LTD., Shenzhen (CN)

(72) Inventors: Chaobin CHEN, Shenzhen (CN); Qiming LIU, Shenzhen (CN)

(21) Appl. No.: 16/703,364

(22) Filed: Dec. 4, 2019

Related U.S. Application Data
(63) Continuation of application No. PCT/CN2017/088390, filed on Jun. 15, 2017.

(51) Int. Cl. G05D 1/00; G06F 9/54; B64C 39/02; H04L 9/06

(52) U.S. Cl. CPC G05D 1/0022; G05D 1/0016; G06F 9/546; B64C 2201/146; B64C 39/024; H04L 9/0643; B64C 2201/12; G06F 9/541

(57) ABSTRACT

A parameter processing method for an unmanned aerial vehicle (“UAV”) includes receiving a message from a control device, the message carrying a parameter identification and interface information. The parameter processing method also includes determining parameter information corresponding to the parameter identification and a function type corresponding to the interface information. The parameter processing method further includes executing an operation corresponding to the function type based on the parameter information.

### CROSS-REFERENCE TO RELATED APPLICATION

This application is a continuation application of International Application No. PCT/CN2017/088390, filed on Jun. 15, 2017, the entire content of which is incorporated herein by reference.

### TECHNICAL FIELD

The present disclosure relates to the technology field of unmanned aerial vehicles (“UAVs”) and, more particularly, to a parameter processing method, a device, a machine readable storage medium and a system.

### BACKGROUND

Unmanned vehicles, such as unmanned aerial vehicles (“UAVs”), have been developed and used in various fields, including consumer applications and industrial applications. For example, the UAVs have been operated for entertainment, photography/video recording, surveillance, delivery, or other applications. UAVs have expanded various aspects of people's life.

However, in traditional technologies, to adjust a flight control parameter of the UAV, a large number of software development kit (“SDK”) interfaces need to be provided on the UAV. Whenever a new function is added, a new SDK interface needs to be added. As a result, the number of SDK interfaces is large, and the processing efficiency is low.

### SUMMARY

In accordance with an aspect of the present disclosure, there is provided a parameter processing method for an unmanned aerial vehicle (“UAV”). The parameter processing method includes receiving a message from a control device, the message carrying a parameter identification and interface information. The parameter processing method also includes determining parameter information corresponding to the parameter identification and a function type corresponding to the interface information. The parameter processing method further includes executing an operation corresponding to the function type based on the parameter information.

In accordance with another aspect of the present disclosure, there is provided a parameter processing method for a control device. The parameter processing method includes determining a parameter identification corresponding to a parameter to be processed and a function type. The parameter processing method also includes determining interface information corresponding to the function type. The parameter processing method further includes transmitting to an unmanned aerial vehicle (“UAV”) a message carrying the parameter identification and the interface information to enable the UAV to perform a corresponding operation based on the parameter identification and the interface information.

In accordance with another aspect of the present disclosure, there is provided an unmanned aerial vehicle (“UAV”). The UAV includes a receiver configured to receive a message carrying parameter identification and interface information from a control device. The UAV also includes an API processor configured to determine a function type corresponding to the interface information. The UAV further includes a flight controller configured to determine parameter information corresponding to the parameter identification, and execute an operation corresponding to the function type based on the parameter information.

In accordance with another aspect of the present disclosure, there is provided a parameter processing system. The parameter processing system includes an unmanned aerial vehicle (“UAV”). The parameter processing system also includes a control device configured to determine a parameter identification corresponding to a parameter to be processed and a function type, to determine interface information corresponding to the function type, and to transmit to the UAV a message carrying the parameter identification and the interface information. The UAV is configured to receive the message from the control device, the message carrying the parameter identification and the interface information, to determine parameter information corresponding to the parameter identification and the function type corresponding to the interface information, and to execute an operation corresponding to the function type based on the parameter information.

According to the technical solutions of the present disclosure, the control device may dynamically process the parameters in batches, thereby improving the flexibility and enhancing the expandability of the UAV in various industrial applications. Through authority management, control devices of different authorities may be configured to operate a specified portion of the parameters, thereby reducing the risk of the UAV.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is schematic illustration of an application scene, according to an example embodiment.

FIG. 2A and FIG. 2B are flow charts illustrating a parameter processing method, according to an example embodiment.

FIG. 3A is a schematic illustration of an application scene, according to an example embodiment.

FIG. 3B is a flow chart illustrating a parameter processing method, according to another example embodiment.

FIG. 4 is a schematic diagram of a UAV, according to an example embodiment.

FIG. 5 is a schematic diagram of a control device, according to an example embodiment.

### DETAILED DESCRIPTION OF THE EMBODIMENTS

Next, the technical solutions of the present disclosure will be described in detail with reference to the accompanying drawings. The described embodiments are only some, but not all of the embodiments of the present disclosure. Based on the described embodiments, a person having ordinary skills in the art can modify or improve the various features of the present disclosure without departing from the principle of the various embodiments disclosed herein and without making creative efforts. Such modification or improvement also fall within the scope of the present disclosure.

The terms used in the present disclosure are only for the purpose of describing certain embodiments, and are not intended to limit the scope of the present disclosure. Singular forms of “a,” “said,” “the” used in the present description also include plural forms, unless otherwise indicated explicitly in the context to include other meaning.

Although the present disclosure may use terms such as “first,” “second,” “third,” etc., to describe various types of information, such information is not limited by such terms. The terms are used to distinguish the information of the same type. For example, without departing from the scope of the present disclosure, the first information may also be referred to as the second information. Likewise, the second information may also be referred to as the first information. Depending on the context, the term “if” may be interpreted as “as,” or “when,” or “in response to.”

The terms “comprise,” “comprising,” “include,” and the like specify the presence of stated features, steps, operations, elements, and/or components but do not preclude the presence or addition of one or more other features, steps, operations, elements, components, and/or groups. The term “communicatively couple(d)” or “communicatively connect(ed)” indicates that related items are coupled or connected through a communication channel, such as a wired or wireless communication channel. The term “unit,” “sub-unit,” or “module” may encompass a hardware component, a software component, or a combination thereof. For example, a “unit,” “sub-unit,” or “module” may include a housing, a device, a sensor, a processor, an algorithm, a circuit, an electrical or mechanical connector, etc. The term “processor” may include any suitable processor, which may include hardware, software, or a combination thereof. The processor may be a generic processor or a dedicated processor, which may be specifically programmed to perform certain functions.

A person having ordinary skill in the art can appreciate that when the term “and/or” is used, the term describes a relationship between related items. It should be understood, the term “and/or” refers to any or all combinations of the one or more associated, listed items. For example, A and/or B can mean A only, A and B, and B only. The symbol “/” means “or” between the related items separated by the symbol. The phrase “at least one of” A, B, or C encompasses all combinations of A, B, and C, such as A only, B only, C only, A and B, B and C, A and C, and A, B, and C. The term “and/or” may be interpreted as “at least one of.”

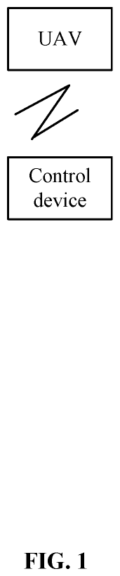

The present disclosure provides a parameter processing method. The parameter processing method may be implemented in a system including a control device and a UAV. The control device may be a remote controller, a mobile terminal (e.g., a cell phone), a wristband, a smart watch, an on-board computer of the UAV, a micro controller unit (“MCU”), a personal computer (“PC”), etc. The present disclosure does not limit the type of the control device. All external devices that support the SDK communication protocol are within the scope of the present disclosure. In addition, these types of control devices may be referred to as SDK devices. As shown in FIG. 1, an application scene of the parameter processing method is shown. In some embodiments, the control device may communicate with the UAV. The connection method between the control device and the UAV is not limited to wired connection or wireless connection. The present disclosure does not limit the connection method. For illustrative purposes, the connection method shown in FIG. 1 uses a wireless connection (e.g., WiFi, OcuSync, Lightbridge, and Auxiliary, etc.) as an example.

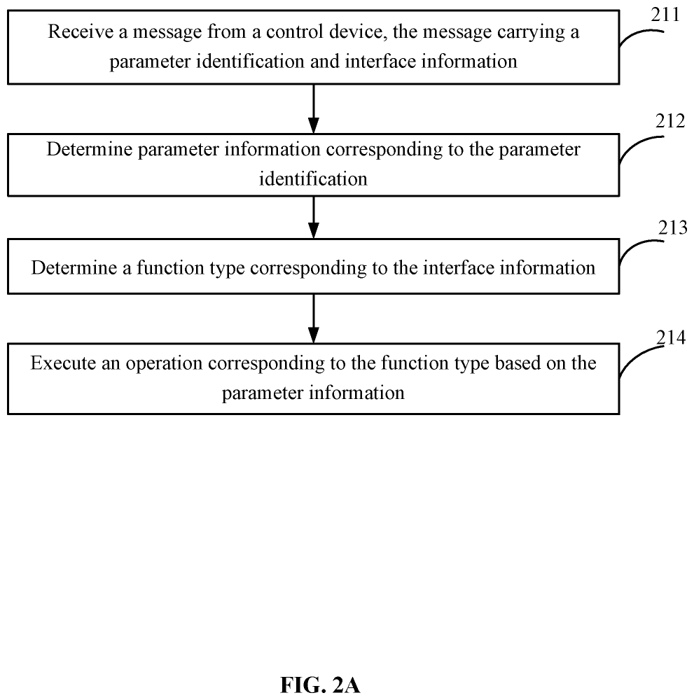

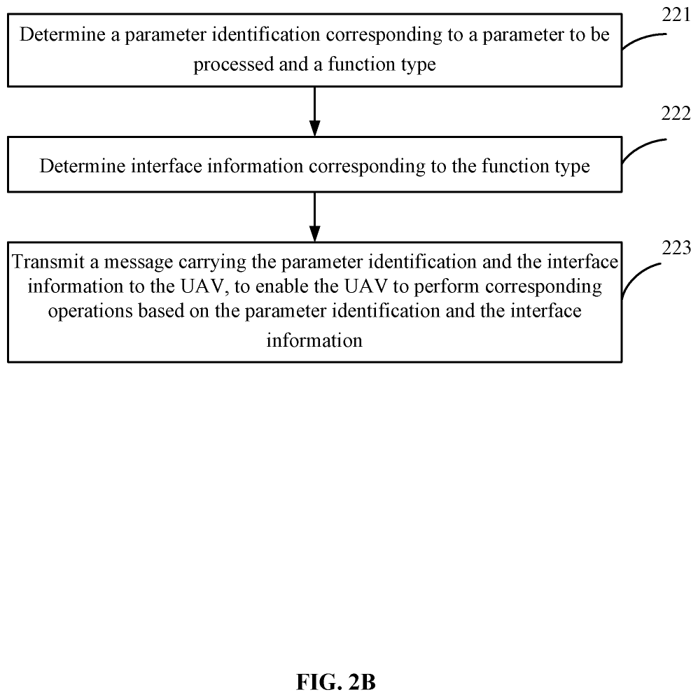

FIG. 2A shows a flow chart illustrating a parameter processing method. The method may be implemented in the UAV.

Step 211: receiving a message from a control device, the message carrying a parameter identification and interface information.

Step 212: determining parameter information corresponding to the parameter identification.

In some embodiments, the UAV may store a parameter table. The parameter table may be configured to record a corresponding relationship between parameter names and parameter information. Based on this, with respect to the process of “determining parameter information corresponding to the parameter identification,” the process may include, but not be limited to, the following methods: if the parameter identification is a parameter name, the parameter table may be inquired based on the parameter name to obtain parameter information corresponding to the parameter name; or, if the parameter identification is a hash value, the hash value may be converted into the parameter name, and the parameter table may be inquired based on the converted parameter name to obtain the parameter information corresponding to the converted parameter name; or if the parameter identification is a hash value, the parameter name in the parameter table may be converted into a hash value corresponding to the parameter name, to directly obtain all parameter information included in the parameter table.

Step 213: determining a function type corresponding to the interface information.

In some embodiments, with respect to the process of “determining a function type corresponding to the interface information,” the process may include, but not be limited to, the following methods: inquiring an Application Programming Interface (“API”) mapping table based on the interface information, to obtain the function type corresponding to the interface information. The API mapping table may be configured to record the corresponding relationship between the interface information and the function type.

Step 214: executing an operation corresponding to the function type based on the parameter information.

In some embodiments, with respect to the process of “executing an operation corresponding to the function type based on the parameter information,” the process may include: obtaining a first authority level of the control device and a second authority level of the parameter information; if the first authority level is higher than or equal to the second authority level, executing the operation corresponding to the function type based on the parameter information; otherwise, declining to execute the operation corresponding to the function type.

In some embodiments, with respect to the process of “executing an operation corresponding to the function type based on the parameter information,” the process may include: if the function type is an acquisition type, transmitting the parameter information to the control device; or, if the function type is a reading type, transmitting the parameter value included in the parameter information to the control device; or, if the function type is a setting type, analyzing the message to obtain a parameter value corresponding to the parameter identification, and revising the parameter value included in the parameter information based on the obtained parameter value corresponding to the parameter identification; or, if the function type is a resetting type, resetting the parameter value included in the parameter information; or, if the function type is a subscribing type, analyzing the message to obtain a transmitting frequency corresponding to the parameter identification, and periodically transmitting the parameter value included in the parameter information based on the transmitting frequency.

In some embodiments, with respect to the process of “revising the parameter value included in the parameter information based on the obtained parameter value corresponding to the parameter identification,” the process may include: if the parameter information includes a read-write property, and if the parameter value corresponding to the parameter identification is legitimate, revising the parameter value included in the parameter information based on the obtained parameter value corresponding to the parameter identification.

In some embodiments, with respect to the process of “resetting the parameter value included in the parameter information,” the process may include: if the parameter information includes a read-write property, resetting the parameter value included in the parameter information, and transmitting a result of the resetting (success or failure) to the control device. In some embodiments, in the process of “resetting the parameter value included in the parameter information,” resetting some parameter values included in the parameter information, or resetting all parameter values included in the parameter information.

In some embodiments, with respect to the process of “periodically transmitting the parameter value included in the parameter information based on the transmitting frequency,” the process may include: if the transmitting frequency is greater than a first predetermined value, and smaller than a second predetermined value, periodically transmitting the parameter value included in the parameter information based on the transmitting frequency. In some embodiments, the first predetermined value and the second predetermined value may be configured based on experience. In some embodiments, the first predetermined value may be smaller than the second predetermined value.

In the above embodiments, the parameter information may include, but not be limited to, any one of the following or a combination thereof: a parameter name; an authority level; a data type; a parameter value; a storage property; a default value; a minimum value; a maximum value. The storage property may be a read-write property or a read-only property. The parameter value is a value corresponding to a parameter name, such as 10, 20, 15, etc. for example, for different parameter names, the corresponding parameter values may be a temperature value (i.e., corresponding to the parameter name of temperature, the value may be 15 degrees, this “15 degrees” is the parameter value), a height value (e.g., 3 meters, etc.), a velocity value (e.g., 6 meter/second etc.), the acceleration value (e.g., 5 meter/second), etc.

Based on the above technical solutions, in the present disclosure, the control device may dynamically process the parameters in batches, thereby improving the flexibility and enhancing the expandability of the UAV in various industrial applications. Through authority management, control devices of different authorities may be configured to operate a specified portion of the parameters, thereby reducing the risk of the UAV.

FIG. 2B is a flow chart illustrating a parameter processing method. The method may be implemented in the control device.

Step 221: determining a parameter identification corresponding to a parameter to be processed and a function type. The parameter identification may be any one or a combination of: a parameter name, or a hash value corresponding to the parameter name, or a predetermined identification.

Step 222: determining interface information corresponding to the function type.

In some embodiments, with respect to the process of “determining interface information corresponding to the function type,” the process may include: inquiring an API mapping table through the function type to obtain the interface information corresponding to the function type. The API mapping table may be configured to record a relationship between the interface information and the function type.

Step 223: transmitting a message carrying the parameter identification and the interface information to the UAV, to enable the UAV to perform corresponding operations based on the parameter identification and the interface information. The operations can refer to the flow chart shown in FIG. 2A.

In some embodiments, if the function type is an acquisition type, the message may be configured to enable the UAV to transmit the parameter information to the control device; or if the function type is a reading type, the message may be configured to enable the UAV to transmit the parameter value included in the parameter information to the control device; or if the function type is a setting type, the message may be configured to enable the UAV to revise the parameter value included in the parameter information; or if the function type is the resetting type, the message may be configured to enable the UAV to reset the parameter value included in the parameter information; or if the function type is the subscribing type, the message may be configured to enable the UAV to periodically transmit the parameter value included in the parameter information to the control device based on a transmission frequency.

Based on the above technical solutions, in the present disclosure, the control device may dynamically process the parameters in batches, thereby improving the flexibility and enhancing the expandability of the UAV in various industrial applications. Through authority management, control devices of different authorities may be configured to operate a specified portion of the parameters, thereby reducing the risk of the UAV.

The parameter processing method will be explained in detail with the following detailed embodiments.

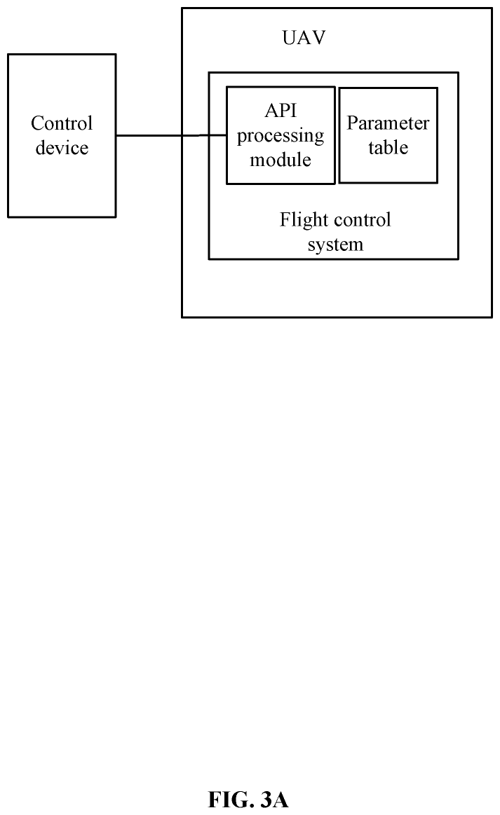

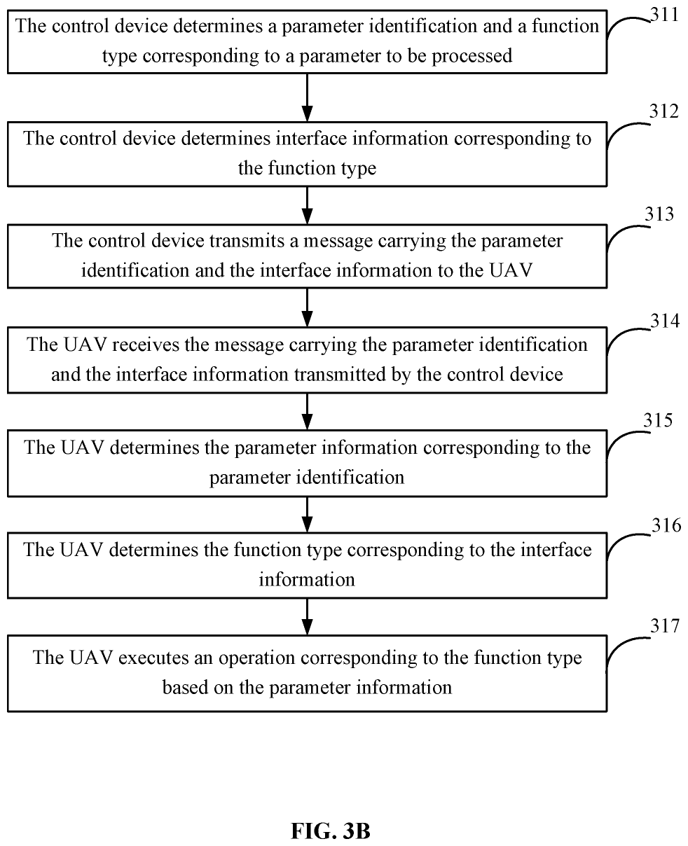

As shown in FIG. 3A, the UAV may include a flight control (“FC”) system, an API processing module, and a parameter table. The flight control system may be realized through a flight controller, and may be configured to implement flight control of the UAV, and various functional logics. The API processing module may be included in the flight control system, and may be realized through an API processor. The API processing module may be configured to analyze the message transmitted by the control device to obtain a corresponding function type, and may provide the function type to the flight control system. The parameter table may be located inside the flight control system, and may be configured to record a corresponding relationship between the parameter names and the parameter information. In actual applications, the UAV may also include other functional modules, which is not limited by the present disclosure. The subsequent descriptions use the processing performed by the UAV as an example.

In some embodiments, the parameter table may be configured to record the corresponding relationship between the parameter names and the parameter information. The parameter information may include, but not limited to, one or any combination of: a parameter name; an authority level; a data type; a parameter value; a storage property; a default value; a minimum value; or a maximum value. The content of the parameter information is not limited to the above listed content, and may include other content, which is not limited by the present disclosure.

As shown in Table 1, which is an example of the parameter table, the storage parameter may be a read-write (“R/W”) property or a read-only (“R”) property. The read-write property refers to: the parameter information can be read or retrieved, and the parameter value included in the parameter information can be revised. The read-only property refers to: the parameter information can be read, but the parameter value included in the parameter information is not permitted to be revised. Further, if the storage property is the read-write property, the parameter information may include, but not be limited to: a parameter name, an authority level, a data type, a parameter value, a storage property, a default value, a minimum value, or a maximum value. In addition, if the storage property is the read-only property, the parameter information may include, but not be limited to: a parameter name, an authority level, a data type, a parameter value, or a storage property.

TABLE 1

| Parameter | Authority | Data | Parameter | Storage | Default | Minimum | Maximum |
|---|---|---|---|---|---|---|---|
| name | level | type | value | property | value | value | value |
| Parameter | L1 | u8 | Parameter | R/W | 1 | 0 | 2 |
| name 1 | | | value A | | | | |
| Parameter | L0 | u16 | Parameter | R/W | 1000 | 800 | 2000 |
| name 2 | | | value B | | | | |
| Parameter | L2 | u32 | Parameter | R/W | 70000 | 60000 | 80000 |
| name 3 | | | value C | | | | |
| Parameter | L3 | u8 | Parameter | R | | | |
| name 4 | | | value D | | | | |

In Table 1, each record represents a piece of parameter information. The parameter name may be a unique identification of the parameter information (and in some embodiments, may be the only identification of the parameter information). Further, the authority level may be divided into several levels, such as L0, L1, L2, L3, etc. L3 authority level may be higher than L2 authority level, L2 authority level may be higher than L1 authority level, L1 authority level may be higher than L0 authority level. The authority level may include other levels, such as L4, L5, etc. Each parameter information may correspond to an authority level. In some embodiments, only when the authority level of the control device is higher than or equal to the authority level of the parameter information, the control device is allowed to operate or process the parameter information (detailed operation method is included in the subsequent description of the following embodiments). When the authority level of the control device is lower than the authority level of the parameter information, the control device is not allowed to operate the parameter information.

In addition, the data type indicates the storage type of the parameter information, such as Integer, Long, Single, Double, and Currency, etc. The word “u8” in Table 1 indicates Integer with a 1 byte (i.e., 8 bits) storage space, “u16” indicates Integer with a 2-byte (i.e., 16 bits) storage space, “u32” indicates Integer with a 4-byte (i.e., 32 bits) storage space.

In addition, a parameter value is a parameter value of the parameter information. The parameter A, parameter B, parameter C, and parameter D shown in Table 1 are illustrative examples. In actual applications, the parameter value may be a numerical value, indicating a number corresponding to the parameter name, such as 10, 20, 15, etc. For example, the parameter value may be a numerical value of the temperature (i.e., for the “temperature” parameter name, the numerical value may be 15 degrees, and this 15 degrees is the parameter value), a numerical value of the height, a numerical value of the velocity, a numerical value of the acceleration, etc. The present disclosure does not limit the parameter value.

In addition, the minimum value indicates the minimum value range of the parameter value, and the maximum value indicates the maximum value range of the parameter value. The default value indicates the default value of the parameter value. For example, the minimum value of the parameter value A may be 0, the maximum value of the parameter value A may be 2, then the value range of the parameter value A may be [0, 2]. When the control device resets the parameter value A, the parameter value A may be restored to the default value of 1. For another example, the minimum value of the parameter value B may be 800, the maximum value of the parameter value B may be 2000, then the value range of the parameter value B may be [800, 2000]. When the control device resets the parameter value B, the parameter value B may be restored to the default value of 1000. Other parameter values can be similarly described.

The content shown in Table 1 is merely one example. In actual applications, the content that can be included in Table 1 is not limited to the above content. For example, Table 1 does not show default values, which may be nonetheless included in Table 1. The present disclosure does not limit the content of the parameter information.

In the above application scenes, referring to FIG. 3B, the parameter processing method may include the following steps.

Step 311: the control device determines a parameter identification and a function type corresponding to a parameter to be processed.

In some embodiments, when the control device operates or processes the parameter information of the UAV, the control device may obtain the function type corresponding to the operation, such as a function type input by a user through the control device, or a function type transmitted to the control device from another device. Such function type may be the function type corresponding to the parameter to be processed. The function type may be an acquisition type, a reading type, a setting type, a resetting type, a subscribing type.

In some embodiments, the parameter identification may include: a parameter name, a hash value corresponding to the parameter name, or a predetermined identification, etc. when the control device operates the parameter information of the UAV, the control device may obtain the parameter name corresponding to the operation, such as a parameter name input by the user through the control device, or a parameter name transmitted to the control device from another device. In the subsequent descriptions, parameter name 1 is used as an example.

In some embodiments, if the parameter identification is the parameter name, the parameter name 1 may be determined as the parameter identification corresponding to the parameter to be processed. If the parameter identification is the has value corresponding to the parameter name, the parameter name 1 may be converted to hash value A, and hash value A may be determined as the parameter identification corresponding to the parameter to be processed. The control device may convert the parameter name 1 into the hash value A based on a preconfigured hash algorithm (e.g., hash algorithm X). The detailed conversion process is omitted. In addition, if all of the parameter information of the UAV is to be operated, the parameter identification may be a predetermined identification (e.g., AAA, etc.), and this predetermined identification may be configured to indicate that all of the parameter information of the UAV is to be operated.

Step 312: the control device determines interface information corresponding to the function type.

In some embodiments, an API mapping table may be configured at the control device. The API mapping table may be configured to record a corresponding relationship between the interface information and the function type. Based on the API mapping table, after the function type is determined, the API mapping table may be inquired based on the function type to obtain the interface information corresponding to the function type.

As shown in Table 2, which is an example of the API mapping table, when the function type is the acquisition type, the interface information is interface information A; when the function type is the reading type, the interface information is interface information B; when the function type is the setting type, the interface information is the interface information C; when the function type is the resetting type, the interface information is the interface information D; when the function type is the subscribing type, the interface information is the interface information E.

TABLE 2

| Function type | Interface information |
|---|---|
| Acquisition type | Interface information A |
| Reading type | Interface information B |
| Setting type | Interface information C |
| Resetting type | Interface information D |
| Subscribing type | Interface information E |

In some embodiments, the above interface information may refer to: pre-arranged information between the control device and the UAV, which may be realized through this API method. The function type may be uniquely determined based on the interface information. The present disclosure does not limit the content of the interface information, as long as the interface information may be used to recognize the function type. For example, the interface information A may be configured to indicate that the function type is the acquisition type, interface information B may be configured to indicate that the function type is the reading type, the interface information C may be configured to indicate that the function type is the setting type, the interface information D may be configured to indicate that the function type is the resetting type, and the interface information E may be configured to indicate that the function type is the subscribing type.

Step 313: the control device transmits a message carrying the parameter identification and the interface information to the UAV.

Step 314: the UAV receives the message carrying the parameter identification and the interface information transmitted by the control device.

Step 315: the UAV determines the parameter information corresponding to the parameter identification.

In some embodiments, the process of the UAV determining the parameter information corresponding to the parameter identification may include:

Method 1: if the parameter identification carried by the message is the parameter name, then the UAV may inquire the parameter table based on the parameter name to obtain the parameter information corresponding to the parameter name.

For example, if the parameter identification carried by the message is parameter name 1, then the UAV may inquire the parameter table shown in Table 1 based on the parameter name 1 to obtain the corresponding parameter information. In some embodiments, the parameter information may include: the parameter name being the parameter name 1, the authority level being L1, the data type being u8, the parameter value being parameter value A, the storage property being R/W, the default value being 1, the minimum value being 0, and the maximum value being 2.

Method 2: if the parameter identification carried by the message is a hash value, the UAV may convert the hash value into a parameter name, and may inquire the parameter table based on the converted parameter name to obtain the parameter information corresponding to the converted parameter name. In some embodiments, the UAV may convert a hash value into a parameter name based on a preconfigured hash algorithm (e.g., the inverse operation of the hash algorithm X configured at the control device). Description of the conversion process is omitted.

For example, if the parameter identification carried by the message is hash value A, then the UAV may convert the hash value A into the parameter name 1 based on the preconfigured hash algorithm, and may inquire the parameter table shown in Table 1 based on the parameter name 1 to obtain the corresponding parameter information. In some embodiments, the obtained parameter information may include: the parameter name being parameter name 1, the authority level being L1, the data type being u8, the parameter value being parameter value A, the storage property being R/W, the default value being 1, the minimum value being 0, and the maximum value being 2.

Method 3: if the parameter identification carried by the message is a hash value, then the UAV may convert each parameter name included in the parameter table into a hash value corresponding to each parameter name, and may inquire the converted parameter table based on a hash value carried by the message to obtain the parameter information corresponding to the hash value carried by the message. In some embodiments, the UAV may convert a parameter name into a hash value based on a preconfigured hash algorithm (e.g., which is the same as the hash algorithm X configured at the control device). Description of the conversion process is omitted.

For example, if the parameter identification carried by the message is hash value A, then the UAV may convert each parameter name included in the parameter table into a hash value based on a preconfigured hash algorithm X (which may be the same as that configured at the control device). A converted parameter table is shown in Table 3. Then, the UAV may inquire the parameter table shown in Table 3 based on the hash value A to obtain the corresponding parameter information. The obtained parameter information may include: the parameter name being the hash value A, the authority level being L1, the data type being u8, the parameter value being parameter value A, the storage property being R/W, the default value being 1, the minimum value being 0, and the maximum value being 2.

TABLE 3

| Parameter | Authority | Data | Parameter | Storage | Default | Minimum | Maximum |
|---|---|---|---|---|---|---|---|
| name | level | type | value | property | value | value | value |
| Hash value A | L1 | u8 | Parameter | R/W | 1 | 0 | 2 |
| | | | value A | | | | |
| Hash value B | L0 | u16 | Parameter | R/W | 1000 | 800 | 2000 |
| | | | value B | | | | |
| Hash value C | L2 | u32 | Parameter | R/W | 70000 | 60000 | 80000 |
| | | | value C | | | | |
| Hash value D | L3 | u8 | Parameter | R | | | |
| | | | value D | | | | |

Method 4: if the parameter identification carried by the message is a predetermined identification (e.g., AAA, etc.), then the UAV may directly obtain all the parameter information included in the parameter table, such as the 4 pieces of parameter information shown in Table 1.

Step 316: the UAV determines the function type corresponding to the interface information.

In some embodiments, an API mapping table may be configured at the UAV. The API mapping table may be configured to record a corresponding relationship between the interface information and the function type. Based on the API mapping table, after the interface information is determined, the API mapping table may be inquired based on the interface information to obtain the function type corresponding to the interface information.

As shown in Table 4, which is an example of the API mapping table, when the function type is an acquisition type, the interface information may be interface information A; when the function type is a reading type, the interface information may be interface information B; when the function type is a setting type, the interface information may be interface information C; when the function type is a resetting type, the interface information may be interface information D; when the function type is a subscribing type, the interface information may be interface information E.

TABLE 4

| Interface information | Function type |
|---|---|
| Interface information A | Acquisition type |
| Interface information B | Reading type |
| Interface information C | Setting type |
| Interface information D | Resetting type |
| Interface information E | Subscribing type |

In some embodiments, the interface information may include: pre-arranged information between the control device and the UAV, which may be realized through this API method. The function type may be uniquely determined based on the interface information. The present disclosure does not limit the content of the interface information, as long as the interface information may be used to recognize the function type. For example, the interface information A may be configured to indicate that the function type is the acquisition type, interface information B may be configured to indicate that the function type is the reading type, the interface information C may be configured to indicate that the function type is the setting type, the interface information D may be configured to indicate that the function type is the resetting type, and the interface information E may be configured to indicate that the function type is the subscribing type.

Step 317: the UAV executes an operation corresponding to the function type based on the parameter information.

In some embodiments, if the message only carries one parameter identification, if the parameter information corresponding to the parameter identification is obtained through inquiry, then the UAV may execute an operation corresponding to the function type based on the parameter information. If the parameter information corresponding to the parameter identification is not obtained through the inquiry, then the UAV may decline to process the message.

In some embodiments, if the message carries multiple parameter identifications, and if the parameter information corresponding to all of the parameter identifications is obtained through the inquiry, then the UAV may execute the operations corresponding to the obtained parameter information. If no parameter information corresponding to any parameter identification is obtained through the inquiry, then the UAV may decline to process the message. If the parameter information corresponding to some parameter identifications is obtained through the inquiry, but the parameter information corresponding to the rest of the parameter identifications is not obtained through the inquiry, then the UAV may decline to process the message. Alternatively, the UAV may execute operations corresponding to parameter information corresponding to the some parameter identifications, and may decline to process the rest of the parameter identifications.

In some embodiments, if the message only carries one parameter identification, and the parameter information corresponding to the parameter identification is obtained through the inquiry, then the UAV may obtain a first authority level of the control device and a second authority level of the parameter information. If the first authority level is higher than the second authority level, then the UAV may execute an operation corresponding to the function type based on the parameter information. If the first authority level is lower than the second authority level, then the UAV may decline to process the message, i.e., decline to execute an operation corresponding to the function type.

In some embodiments, if the message carries multiple parameter identifications, and if parameter information corresponding to all of the parameter identifications is obtained through the inquiry, then the UAV may obtain a first authority level of the control device and a second authority level of each piece of parameter information. If the first authority level is higher than the second authority level of each piece of parameter information, then the UAV may execute an operation corresponding to each piece of parameter information obtained through the inquiry. If the first authority level is lower than the second authority level of any piece of the parameter information, then the UAV may decline to process the message. If the first authority level is higher than or equal to the second authority levels of some pieces of parameter information, but lower than the second authority level of the remaining pieces of parameter information, then the UAV may decline to process the message. Alternatively, the UAV may execute operations corresponding to the some pieces of parameter information, but decline to process the remaining pieces of parameter information.

Next, the process of executing an operation corresponding to the function type will be described in detail with reference to detailed situations.

Situation One: if the function type is an acquisition type, then after the parameter information is obtained through the inquiry, the UAV may transmit the parameter information to the control device. For example, the UAV may transmit the following parameter information to the control device: “parameter name being hash value A, authority level being L1, data type being u8, parameter value being parameter value A, storage property being R/W, default value being 1, minimum value being 0, and maximum value being 2.”

Situation Two: if the function type is a reading type, after the parameter information is obtained through the inquiry, the UAV may transmit the parameter value included in the parameter information to the control device. In actual applications, when there are multiple parameter values, the UAV may return the parameter values sequentially one by one.

For example, when the number of parameter value is 1, the UAV may transmit “parameter value A” to the control device. As another example, assuming that the messages transmitted by the control device to the UAV sequentially carry parameter name 1, parameter name 2, and parameter name 3. Then the number of the parameter values is multiple, such as parameter value A, parameter value B, and parameter value C. Based on this, the UAV may transmit “parameter value A” to the control device through a first response message, transmit “parameter value B” to the control device through a second response message, and transmit “parameter value C” to the control device through a third response message. Alternatively, the UAV may sequentially add “parameter value A, parameter value B, parameter value C” into the response message, and may transmit the response message to the control device.

Situation Three: if the function type is a setting type, then the UAV may analyze the message to obtain a parameter value corresponding to the parameter identification (i.e., in the message transmitted by the control device to the UAV, in addition to carrying the parameter identification and interface information, the message may also carry the parameter value corresponding to the parameter identification), and may revise the parameter value included in the parameter information based on the parameter value obtained from analyzing the message. For example, assuming that the message also carries parameter value E corresponding to parameter name 1, then the UAV may change the “parameter value A” in Table 1 to “parameter value E.”

In some embodiments, the process of “revising the parameter value included in the parameter information based on the obtained parameter corresponding to the parameter identification” may include: if the parameter information includes the read-write property, and the parameter value corresponding to the parameter identification is legitimate, then the UAV may revise the parameter value included in the parameter information based on the parameter value corresponding to the parameter identification. In addition, if the parameter information includes the read property, and/or, if the parameter value corresponding to the parameter identification is illegitimate, then the UAV may decline to revise the parameter value included in the parameter information based on the parameter value corresponding to the parameter identification.

In some embodiments, if the parameter value corresponding to the parameter identification carried by the message is greater than the minimum value corresponding to the parameter information, and is smaller than the maximum value corresponding to the parameter information, then it may be determined that the parameter value corresponding to the parameter identification is legitimate; otherwise, it may be determined that the parameter value corresponding to the parameter identification is illegitimate.

In some embodiments, after revising the parameter value included in the parameter information based on the parameter value corresponding to the parameter identification, the UAV may transmit a result of a successful revision or a failed revision to the control device.

Situation four: if the function type is the resetting type, then the UAV may reset the parameter value included in the parameter information. For example, assuming the message carries the parameter name 1, then the UAV may perform a resetting process on “parameter value A.” That is, the UAV may change the “parameter value A” to the default value of 1.

In some embodiments, the process of “resetting the parameter value included in the parameter information” may include: if the parameter information includes the read-write property, then the UAV may reset the parameter value included in the parameter information, and the UAV may transmit a result of the successful resetting or the failed resetting to the control device. In some embodiments, during the process of “resetting the parameter value included in the parameter information,” some parameter values included in the parameter information may be reset, or all parameter values included in the parameter information may be reset.

In some embodiments, if the parameter identification carried by the message is a predetermined identification (e.g., AAA, etc.), the UAV may reset the parameter value included in the parameter information in the parameter table. For example, the UAV may reset the parameter values (some or all parameter values) included in the four pieces of parameter information in Table 1.

Situation five: if the function type is the subscribing type, the UAV may analyze the message to obtain a transmission frequency corresponding to the parameter identification (i.e., in the message transmitted by the control device to the UAV, in addition to the parameter identification and the interface information, the message may also carry the transmission frequency corresponding to the parameter identification), and may periodically transmit the parameter value included in the parameter information to the control device based on the transmission frequency. For example, the UAV may periodically transmit a message carrying “parameter value A” to the control device based on the transmission frequency.

In some embodiments, the process of “transmitting the parameter value included in the parameter information based on the transmission frequency” may include: if the transmission frequency is greater than a first predetermined value, and smaller than a second predetermined value, the UAV may periodically transmit the parameter value included in the parameter information to the control device based on the transmission frequency. If the transmission frequency is smaller than or equal to the first predetermined value, the UAV may decline to transmit the parameter value included in the parameter information to the control device. If the transmission frequency is greater than or equal to the second predetermined value, the UAV may decline to transmit the parameter value included in the parameter information to the control device. In some embodiments, the first predetermined value and the second predetermined value may be configured based on experience, and the first predetermined value may be smaller than the second predetermined value.

In some embodiments, the above processes show some examples of different function types. When the function type is another function type other than the above five function types, the processing method may be similar, which is not repeated.

Based on the above technical solution, in the embodiments of the present disclosure, the control device may dynamically operate or process the parameters in a batch, thereby increasing the flexibility, and enhancing the expandability of the UAV in various industrial applications. Through the management of the authority, control devices having different authorities can only operate some parameters, thereby reducing the risk of the UAV.

In some embodiments, the above implementation realized a UAV flight control dynamic parameter adjustment mechanism that can be integrated into the SDK frame, which allows the developers to realize the following objectives through a few standard interfaces: during the flight, setting the parameters in real time and in a batch (or individually), and obtaining a result of the successful setting or the failed setting; during the flight, resetting some parameters in real time and in a batch (or individually), and obtaining a result of the successful resetting or the failed resetting; during the flight, subscribing open parameters based on a predetermined frequency; all parameters have predetermined authority levels, and a specific developer cannot operate a parameter having an authority level higher than the authority level of the specific developer.

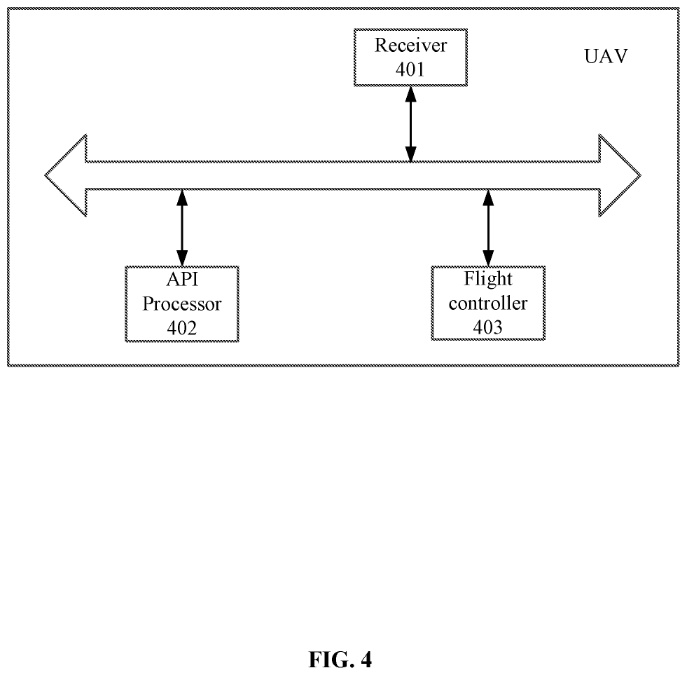

Based on the inventive concept that is similar to or the same as the above method, the present disclosure provides a UAV. As shown in FIG. 4, the UAV may include: a receiver 401 configured to receive a message carrying a parameter identification and interface information from the control device; an API processor 402 configured to determine the function type corresponding to the interface information; a flight controller 403 configured to determine the parameter information corresponding to the parameter identification, and execute an operation corresponding to the function type based on the parameter information.

The UAV may also include (not shown in figures): a parameter storage device; the parameter storage device may be configured to store the parameter table. The parameter table may be configured to record a corresponding relationship between the parameter name and the parameter information.

In some embodiments, the flight controller 403 may be configured to, when determining the parameter information corresponding to the parameter identification, if the parameter identification is the parameter name, inquire the parameter table based on the parameter name to obtain the parameter information corresponding to the parameter name; or, if the parameter identification is a hash value, to convert the hash value into a parameter name, and to inquire the parameter table based on the converted parameter name to obtain the parameter information corresponding to the converted parameter name; or, if the parameter identification is a hash value, to convert a parameter name included in the parameter table to a hash value corresponding to the parameter name, and to inquire the converted parameter table based on a hash value carried by the message to obtain the parameter information corresponding to the hash value carried by the message; or, if the parameter identification is a predetermined identification, to obtain all of the parameter information included in the parameter table.

The API processor 402 may be configured to, when determining the function type corresponding to the interface information, inquire the API mapping table based on the interface information to obtain the function type corresponding to the interface information; in some embodiments, the API mapping table may be configured to record the corresponding relationship between the interface information and the function type.

In some embodiments, the flight controller 403 may be configured to, when executing an operation corresponding to the function type based on the parameter information, obtain a first predetermined authority level of the control device and a second predetermined authority level of the parameter information; if the first predetermined authority level is higher than or equal to the second predetermined authority level, to execute the operation corresponding to the function type based on the parameter information.

In some embodiments, the flight controller 403 may be configured to, when executing the operation corresponding to the function type based on the parameter information, if the function type is the acquisition type, transmit the parameter information to the control device; or, if the function type is the reading type, transmit the parameter value included in the parameter information to the control device; or, if the function type is the setting type, analyze the message to obtain a parameter value corresponding to the parameter identification, and to revise the parameter value included in the parameter information based on the obtained parameter value corresponding to the parameter identification; or, if the function type is the resetting type, reset the parameter value included in the parameter information; or, if the function type is the subscribing type, analyze the message to obtain a transmission frequency corresponding to the parameter identification, and to periodically transmit the parameter value included in the parameter information based on the transmission frequency.

In some embodiments, the flight controller 403 may be configured to, when revising the parameter value included in the parameter information based on the obtained parameter value corresponding to the parameter identification, if the parameter information includes the read-write property, and if the parameter value corresponding to the parameter identification is legitimate, revise the parameter value included in the parameter information based on the parameter value corresponding to the parameter identification.

In some embodiments, the flight controller 403 may be configured to, when resetting the parameter value included in the parameter information, if the parameter information includes the read-write property, reset the parameter value included in the parameter information, and transmit a result of the successful resetting or the failed resetting to the control device.

In some embodiments, the flight controller 403 may be configured to, when periodically transmitting the parameter value included in the parameter information based on the transmission frequency, if the transmission frequency is greater than the first predetermined value, and is smaller than the second predetermined value, periodically transmit the parameter value included in the parameter information based on the transmission frequency.

In some embodiments, the first predetermined value is smaller than the second predetermined value.

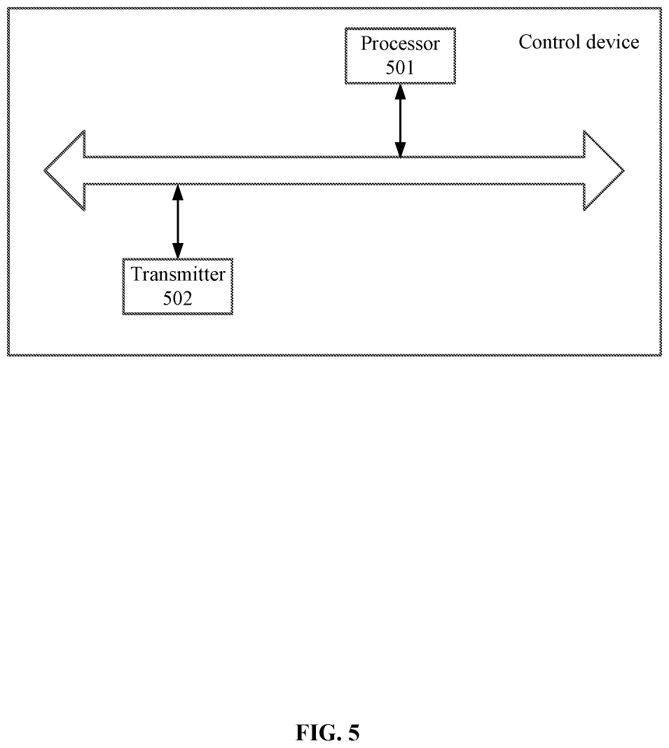

Based on the inventive concept similar to or the same as the above method, the present disclosure provides a control device. As shown in FIG. 5, the control device may include: a processor 501 configured to determine the parameter identification corresponding to a parameter to be processed and the function type, and to determine the interface information corresponding to the function type; a transmitter 502 configured to transmit to the UAV a message carrying the parameter identification and the interface information, to enable the UAV to execute a corresponding operation based on the parameter identification and the interface information.

In some embodiments, the parameter identification may include: a parameter name, or a hash value corresponding to the parameter name, or a predetermined identification; if the function type is the acquisition type, the message may be configured to enable the UAV to transmit the parameter information to the control device; if the function type is the reading type, the message may be configured to enable the UAV to transmit the parameter value included in the parameter information to the control device; if the function type is the setting type, the message may be configured to enable the UAV to revise the parameter value included in the parameter information; if the function type is the resetting type, the message may be configured to enable the UAV to reset the parameter value included in the parameter information; if the function type is the subscribing type, the message may be configured to periodically transmit the parameter value included in the parameter information to the control device based on the transmission frequency.

In some embodiments, the processor 501 may be configured to, when determining the interface information corresponding to the function type, inquire the API mapping table based on the function type to obtain the interface information corresponding to the function type; the API mapping table may be configured to record the corresponding relationship between the interface information and the function type.

Based on the inventive concept similar to or the same as the above method, the present disclosure also provides a non-transitory computer-readable storage medium. The computer-readable storage medium may be implemented in the UAV. The computer-readable storage medium may be configured to store a plurality of computer instructions. The computer instructions may be executed by a processor, such that the processor performs the following operations:

receiving a message from the control device, the message carrying a parameter identification and interface information;

determining parameter information corresponding to the parameter identification, and a function type corresponding to the interface information; and

executing an operation corresponding to the function type based on the parameter information.

In some embodiments, the UAV may store a parameter table configured to record a corresponding relationship between the parameter name and the parameter information. When determining the parameter information corresponding to the parameter identification, the computer instructions may be executed by a processor, such that the processor performs the following operations: if the parameter identification is the parameter name, inquiring the parameter table based on the parameter name to obtain the parameter information corresponding to the parameter name; or, if the parameter identification is a hash value, converting the hash value into a parameter name, and inquiring the parameter table based on the converted parameter name to obtain the parameter information corresponding to the converted parameter name; or, if the parameter identification is a hash value, converting a parameter name included in the parameter table into a hash value, and inquiring the converted parameter table based on a hash value carried by the message to obtain the parameter information corresponding to the hash value carried by the message; or, if the parameter identification is a predetermined identification, obtaining all of the parameter information included in the parameter table.

In some embodiments, when determining the function type corresponding to the interface information, the computer instructions may be executed by the processor, such that the processor performs the following operations: inquiring the API mapping table based on the interface information to obtain the function type corresponding to the interface information; the API mapping table may be configured to record a corresponding relationship between the interface information and the function type.

In some embodiments, when executing the operation corresponding to the function type based on the parameter information, the computer instructions may be executed by the processor, such that the processor performs the following operations: obtaining a first authority level of the control device and a second authority level of the parameter information; if the first authority level is higher than or equal to the second authority level, executing the operation corresponding to the function type based on the parameter information.

In some embodiments, when executing the operation corresponding to the function type based on the parameter information, the computer instructions may be executed by the processor, such that the processor performs the following operations: if the function type is the acquisition type, transmitting the parameter information to the control device; or, if the function type is the reading type, transmitting the parameter value included in the parameter information to the control device; or, if the function type is the setting type, analyzing the message to obtain the parameter value corresponding to the parameter identification, and revising the parameter value included in the parameter information based on the obtained parameter value corresponding to the parameter identification; or, if the function type is the resetting type, resetting the parameter value included in the parameter information; or, if the function type is the subscribing type, analyzing the message to obtain a transmission frequency corresponding to the parameter identification, and periodically transmitting the parameter value included in the parameter information based on the transmission frequency.

In some embodiments, when revising the parameter value included in the parameter information based on the obtained parameter value corresponding to the parameter identification, the computer instructions may be executed by the processor, such that the processor performs the following operations: if the parameter information includes the read-write property, and the parameter value corresponding to the parameter identification is legitimate, revising the parameter value included in the parameter information based on the parameter value corresponding to the parameter identification; when resetting the parameter value included in the parameter information, the computer instructions may be executed by the processor, such that the processor performs the following operations: if the parameter information includes the read-write property, resetting the parameter value included in the parameter information, and transmitting a result of the successful resetting or a failed resetting to the control device; when periodically transmitting the parameter value included in the parameter information based on the transmission frequency, the computer instructions may be executed by the processor, such that the processor performs the following operations: if the transmission frequency is greater than a first predetermined value, and smaller than a second predetermined value, periodically transmitting the parameter value included in the parameter information based on the transmission frequency. The first predetermined value may be smaller than the second predetermined value.

Based on the inventive concept similar to or the same as the above method, the present disclosure provides a non-transitory computer-readable storage medium. The computer-readable storage medium may be implemented in the control device. The computer-readable storage medium may be configured to store a plurality of computer instructions. The computer instructions may be executed by a processor, such that the processor performs the following operations:

determining a parameter identification corresponding to a parameter to be processed and a function type;

determining interface information corresponding to the function type;

determining interface information corresponding to the function type;

transmitting to the UAV a message carrying the parameter identification and the interface information to enable the UAV to perform a corresponding operation based on the parameter identification and the interface information.

When determining the interface information corresponding to the function type, the computer instructions may be executed by the processor, such that the processor performs the following operations: inquiring the API mapping table based on the function type to obtain the interface information corresponding to the function type. The API mapping table may be configured to record a corresponding relationship between the interface information and the function type.

Based on the inventive concept similar to or the same as the above method, the present disclosure also provides a parameter processing system. The parameter processing system may include the UAV and the control device. The control device may be configured to determine a parameter identification corresponding to a parameter to be processed and a function type, and determine the interface information corresponding to the function type, and transmitting to the UAV a message carrying the parameter identification and the interface information. The UAV may be configured to receive the message from the control device. The message may carry the parameter identification and the interface information. The UAV may be configured to determine the parameter information corresponding to the parameter identification and the function type corresponding to the interface information. The UAV may be configured to execute an operation corresponding to the function type based on the parameter information.

In some embodiments, the UAV may be configured to, when executing the operation corresponding to the function type based on the parameter information, if the function type is the acquisition type, transmitting the parameter information to the control device; if the function type is the reading type, transmitting the parameter value included in the parameter information to the control device; if the function type is the setting type, analyzing the message to obtain the parameter value corresponding to the parameter identification, and revising the parameter value included in the parameter information based on the obtained parameter value corresponding to the parameter identification; if the function type is the resetting type, resetting the parameter value included in the parameter information; if the function type is the subscribing type, analyzing the message to obtain the transmission frequency corresponding to the parameter identification, and periodically transmitting the parameter value included in the parameter information based on the transmission frequency.

The system, device, module or unit described in the above embodiments may be realized using a computer chip or a physical entity, or a product having certain functions. A typical realization device is a computer. The detailed form of the computer may be a personal computer, a laptop computer, a cellular phone, a camera phone, a smart phone, a personal digital assistant, a multimedia player, a navigation device, an e-mail receiving and transmitting device, a game control console, a tablet computer, a wearable device, or any combination of two or more of these devices.

For the convenience of descriptions, the above devices are described based on functions being divided as various units. When implementing the present disclosure, functions of various units may be realized in one or multiple software programs and/or hardware components.

A person having ordinary skills in the art can appreciate, the present disclosure may be realized as a method, a system, or a computer program product. As such, the present disclosure may be realized using hardware alone, software alone, or a combination of software and hardware. In addition, the present disclosure may be realized as a computer program product implemented in one or more computer-readable storage media (including but not limited to a magnetic disk, a CD-ROM, an optical device, etc.) that store computer-executable program codes or instructions.

The present disclosure is described with reference to the flow charts and/or block diagrams of the disclosed methods, devices (systems), and computer program products. It should be understood that computer program codes or instructions may be used to realize each step and/or block included in the flow chart and/or block diagram, and a combination of the steps and/or blocks in the flow chart and/or the block diagram. Such computer program codes or instructions may be provided to a generic computer, a dedicated computer, an embedded processor, or a processor of a programmable data processing device to generate a machine, such that a device may be produced through the instructions executed by the computer or other processor of a programmable data processing device. The device may be used to realize a specified function of one or more steps in the flow chart and/or one or more blocks in the block diagram.

In addition, the computer program codes or instructions may be stored in a computer-readable storage medium that may guide a computer or other programmable data processing device to operate in a specified manner, such that instructions stored in the computer-readable storage medium generate a product having an instruction device. The instruction device may realize a specific function of one or more steps in the flow chart and/or one or more blocks of the block diagram.

The computer program codes or instructions may be loaded into a computer or other programmable data processing device, such that a series of steps may be executed on the computer or other programmable data processing device to generate a computer-realized process, such that the codes executed by the computer or other programmable data processing device may provide a step for realizing a specific function of one or more steps of the flow chart and/or one or more blocks of the block diagram.

A person having ordinary skills in the art can appreciate, the embodiments of the present disclosure may be provided as methods, systems, or computer program products. As such, the present disclosure may be implemented in the forms of hardware alone embodiments, software alone embodiments, or embodiments combining software and hardware. In addition, the present disclosure may be implemented as a computer program product that may be implemented in one or more computer-readable storage media (including but not limited to a magnetic disk, a CD-ROM, an optical storage device, etc.) that include computer-executable program codes or instructions.

The above described are only embodiments of the present disclosure, and are not intended to limit the scope of the present disclosure. A person having ordinary skills in the art can modify or change the embodiments of the present disclosure. Such modifications, equivalent substitutions, or improvements within the spirit and principle of the present disclosure all fall within the scope of the claims of the present disclosure.

What is claimed is:

1. A parameter processing method for an unmanned aerial vehicle (“UAV”), comprising:
receiving a message from a control device, the message carrying a parameter identification and interface information;
determining parameter information corresponding to the parameter identification and a function type corresponding to the interface information; and
executing an operation corresponding to the function type based on the parameter information.

2. The parameter processing method of claim 1, wherein the parameter information comprises at least one or a combination of: a parameter name, an authority level, a data type, a parameter value, a storage property, a default value, a minimum value, or a maximum value, wherein the storage property is a read-write property or a read-only property.

3. The parameter processing method of claim 1,
wherein the UAV stores a parameter table configured to record a corresponding relationship between the parameter name and the parameter information, and
wherein determining the parameter information corresponding to the parameter identification comprises:
if the parameter identification is the parameter name, inquiring the parameter table based on the parameter name to obtain the parameter information corresponding to the parameter name;
if the parameter identification is a hash value, converting the hash value into a parameter name, and inquiring the parameter table based on the converted parameter name to obtain the parameter information corresponding to the converted parameter name;
if the parameter identification is a hash value, converting the parameter name included in the parameter table into a hash value corresponding to the parameter name, and inquiring the parameter table based on a hash value carried by the message to obtain the parameter information corresponding to the hash value carried by the message; or
if the parameter identification is a predetermined identification, obtaining all parameter information included in the parameter table.

4. The parameter processing method of claim 1, wherein determining the function type corresponding to the interface information comprises:
inquiring an API mapping table based on the interface information to obtain the function type corresponding to the interface information, wherein the API mapping table is configured to record a corresponding relationship between the interface information and the function type.

5. The parameter processing method of claim 1, wherein executing the operation corresponding to the function type based on the parameter information comprises:
obtaining a first authority level of the control device and a second authority level of the parameter information; and
if the first authority level is higher than or equal to the second authority level, executing the operation corresponding to the function type.

6. The parameter processing method of claim 1, wherein executing the operation corresponding to the function type based on the parameter information comprises:
if the function type is an acquisition type, transmitting the parameter information to the control device;
if the function type is a reading type, transmitting a parameter value included in the parameter information to the control device;
if the function type is a setting type, analyzing the message to obtain a parameter value corresponding to the parameter identification, and revising the parameter value included in the parameter information based on the obtained parameter value corresponding to the parameter identification;
if the function type is a resetting type, resetting the parameter value included in the parameter information; or
if the function type is a subscribing type, analyzing the message to obtain a transmission frequency corresponding to the parameter identification, and periodically transmitting the parameter value included in the parameter information based on the transmission frequency.

7. The parameter processing method of claim 6, wherein revising the parameter value included in the parameter information based on the obtained parameter value corresponding to the parameter identification comprises:
if the parameter information includes a read-write property, and if the parameter value corresponding to the parameter identification is legitimate, revising the parameter value included in the parameter information based on the obtained parameter value corresponding to the parameter identification.

8. The parameter processing method of claim 6, wherein resetting the parameter value included in the parameter information comprises:
if the parameter information includes a read-write property, resetting the parameter value included in the parameter information, and transmitting a result of a successful resetting or a failed resetting to the control device.

9. The parameter processing method of claim 6, wherein periodically transmitting the parameter value included in the parameter information based on the transmission frequency comprises:
if the transmission frequency is greater than a first predetermined value, and is smaller than a second predetermined value, periodically transmitting the parameter value included in the parameter information based on the transmission frequency, wherein the first predetermined value is smaller than the second predetermined value.

10. An unmanned aerial vehicle (“UAV”), comprising:
a receiver configured to receive a message carrying parameter identification and interface information from a control device;
an API processor configured to determine a function type corresponding to the interface information; and
a flight controller configured to determine parameter information corresponding to the parameter identification, and execute an operation corresponding to the function type based on the parameter information.

11. The UAV of claim 10, further comprising:
a parameter storage device configured to store a parameter table, the parameter table configured to record a corresponding relationship between parameter names and parameter information; and
a flight controller configured to, when determining the parameter information corresponding to the parameter identification,
if the parameter identification is a parameter name, inquire the parameter table based on the parameter name to obtain parameter information corresponding to the parameter name;
if the parameter identification is a hash value, convert the hash value into a parameter name, inquire the parameter table based on the parameter name to obtain parameter information corresponding to the parameter name;
if the parameter identification is a hash value, convert the parameter names in the parameter table into hash values, and inquire the converted parameter table based on the hash value carried by the message, to obtain parameter information corresponding to the hash value carried by the message; or
if the parameter identification is a predetermined identification, obtain all the parameter information included in the parameter table.

12. The UAV of claim 10, wherein the API processor is configured to, when determining the function type corresponding to the interface information, inquire an API mapping table based on the interface information, to obtain the function type corresponding to the interface information, wherein the API mapping table is configured to record a corresponding relationship between the interface information and the function type.

13. The UAV of claim 10, wherein the flight controller is configured to, when executing an operation corresponding to the function type based on the parameter information, obtain a first authority level of the control device, a second authority level of the parameter information, and if the first authority level is higher than the second authority level, execute the operation corresponding to the function type based on the parameter information.

14. The UAV of claim 10, wherein the flight controller is configured to, when executing the operation corresponding to the function type based on the parameter information,
if the function type is an acquisition type, transmit the parameter information to the control device;
if the function type is a reading type, transmit a parameter value included in the parameter information to the control device;
if the function type is a setting type, analyze the message to obtain a parameter value corresponding to the parameter identification, and revise the parameter value included in the parameter information based on the parameter value corresponding to the parameter identification;
if the function type is a resetting type, reset the parameter value included in the parameter information; or
if the function type is a prescription type, analyze the message to obtain a transmission frequency corresponding to the parameter identification, and periodically transmit the parameter value included in the parameter information.

15. The UAV of claim 14,
wherein the flight controller is configured to, when revising the parameter value included in the parameter information based on the parameter value corresponding to the parameter identification, if the parameter information is a read-write property, and the parameter value corresponding to the parameter identification is legitimate, revise the parameter value included in the parameter information based on the parameter value corresponding to the parameter identification;
wherein the flight controller is configured to, when resetting the parameter value included in the parameter information, if the parameter information is the read-write property, reset the parameter value included in the parameter information, and transmit a result of a successful resetting or a failed resetting to the control device;
wherein the flight controller is configured to, when periodically transmitting the parameter value included in the parameter information based on the transmission frequency, if the transmission frequency is greater than a first predetermined value, and smaller than a second predetermined value, periodically transmitting the parameter value included in the parameter information based on the transmission frequency, or
wherein the first predetermined value is smaller than the second predetermined value.

16. A parameter processing system, comprising:
an unmanned aerial vehicle (“UAV”); and
a control device configured to determine a parameter identification corresponding to a parameter to be processed and a function type, to determine interface information corresponding to the function type, and to transmit to the UAV a message carrying the parameter identification and the interface information,
wherein the UAV is configured to receive the message from the control device, the message carrying the parameter identification and the interface information, to determine parameter information corresponding to the parameter identification and the function type corresponding to the interface information, and to execute an operation corresponding to the function type based on the parameter information.

17. The parameter processing system of claim 16, further comprising:
a parameter storage device configured to store a parameter table, the parameter table configured to record a corresponding relationship between parameter names and parameter information; and
wherein the UAV includes a flight controller configured to, when determining the parameter information corresponding to the parameter identification:
if the parameter identification is a parameter name, inquire the parameter table based on the parameter name to obtain parameter information corresponding to the parameter name;
if the parameter identification is a hash value, convert the hash value into a parameter name, inquire the parameter table based on the parameter name to obtain parameter information corresponding to the parameter name;
if the parameter identification is a hash value, convert the parameter names in the parameter table into hash values, and inquire the converted parameter table based on the hash value carried by the message, to obtain parameter information corresponding to the hash value carried by the message; or
if the parameter identification is a predetermined identification, obtain all the parameter information included in the parameter table.

18. The parameter processing system of claim 16, wherein the UAV includes an API processor configured to, when determining the function type corresponding to the interface information, inquire an API mapping table based on the interface information, to obtain the function type corresponding to the interface information, wherein the API mapping table is configured to record a corresponding relationship between the interface information and the function type.

19. The parameter processing system of claim 16, wherein the UAV is configured to, when executing the operation corresponding to the function type based on the parameter information, obtain a first authority level of the control device, a second authority level of the parameter information, and if the first authority level is higher than the second authority level, execute the operation corresponding to the function type based on the parameter information.

20. The parameter processing system of claim 16,
wherein the UAV is configured to, when executing the operation corresponding to the function type based on the parameter information:
if the function type is an acquisition type, transmit the parameter information to the control device;
if the function type is a reading type, transmit a parameter value included in the parameter information to the control device;
if the function type is a setting type, analyze the message to obtain a parameter value corresponding to the parameter identification, and revise the parameter value included in the parameter information based on the obtained parameter value corresponding to the parameter identification;
if the function type is a resetting type, reset the parameter value included in the parameter information; or
if the function type is a subscribing type, analyze the message to obtain a transmission frequency corresponding to the parameter identification, and periodically transmit the parameter value included in the parameter information based on the transmission frequency.
